(19) United States
(12) Patent Application Publication
(10) Pub. No.: US 2003/0165063 A1
(43) Pub. Date: Sep. 4, 2003

(54) Light-emitting apparatus for rim cover

(76) Inventor: Shun-Ten Liaw, Yun Lin Hsien (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/087,133

(22) Filed: Mar. 1, 2002

(51) Int. Cl. B60Q 1/26; F21L 14/04

(52) U.S. Cl. 362/500; 362/543; 362/192

(57) ABSTRACT

A light-emitting apparatus for a rim cover is disclosed. The light-emitting apparatus includes a light source and a generator. The light source is attached to the rim cover. The generator is attached to the rim cover. The light source is connected with generator. When the rim cover is rotated, the generator generates electricity in order to power the light source.

### BACKGROUND OF INVENTION

1. Field of Invention

The present invention is related to a rim cover and, more particularly, to a light-emitting apparatus for a rim cover.

2. Related Prior Art

In Taiwan Patent Publication No. 342791, a conventional light-emitting structure for a rim cover of a car is disclosed. This conventional light-emitting structure includes a bulb, a battery for powering the bulb, a circuit board connected with the battery and a centrifugal switch connected with the circuit board. When the rim cover is rotated, a closed circuit is formed between the battery, the circuit board, the centrifugal switch and the bulb, thus activating the bulb. A number of problems are encountered in use of this conventional light-emitting apparatus. Firstly, it is complicated in structure. Secondly, a closed circuit cannot be formed unless the rim cover is rotated fast enough. Thirdly, a closed circuit may be formed unintentionally when the car is parked at a slope. Fourthly, the circuit board and the battery are vulnerable to mud and water. Fifthly, replacement of a used battery with a new battery is troublesome since the rim cover must be removed from a rim beforehand. Sixthly, used batteries cause a serious problem in environment protection.

The present invention is therefore intended to obviate or at least alleviate the drawbacks encountered in the use of the conventional light-emitting apparatus.

### SUMMARY OF INVENTION

It is an objective of the present invention to provide a rim cover with a light-emitting apparatus that is simple in structure.

It is another objective of the present invention to provide a light-emitting apparatus that can be activated even when the rim cover is rotated at a low speed.

It is another objective of the present invention to provide a light-emitting apparatus that cannot be unintentionally activated.

It is another objective of the present invention to provide a light-emitting apparatus that is not vulnerable to mud and water.

It is another objective of the present invention to provide a light-emitting apparatus that is economic to use.

It is another objective of the present invention to provide a light-emitting apparatus that does not need an external power supply.

To achieve the above-mentioned and other objectives, the present invention provides a light-emitting apparatus including a light and a generator. The light source and the generator are both attached to the rim cover. The light source is connected with generator. When the rim cover is rotated, the generator generates electricity in order to power the light source.

The generator includes a magnet and a coil device for rotation with respect to the magnet when the rim cover is rotated, thus generating electricity.

The coil device includes a cylindrical configuration and the magnet is co-axially received in the coil device.

The magnet includes a cylindrical configuration. The generator includes a shaft for carrying the magnet, two bearings for bearing the shaft in the coil device, thus allowing rotation of the coil device with respect to the magnet.

The generator includes a weight attached to the shaft.

The generator includes a mount for mounting the coil device on the rim cover.

The mount includes a disk and a number of feet extending from one side of the disk. Each of the feet defines a hole for receiving a bolt for securing the mount to the rim cover.

The coil device is secured to an opposite side of the disk. The coil device includes a coil and a casing for receiving the coil. The casing includes an internal cylindrical portion integrally connected with an external cylindrical portion by means of two annular portions. The coil is mounted on the internal cylindrical portion of the casing. The external cylindrical portion of the casing defines at least one hole for allowing a cable to extend from the coil to the light source.

### BRIEF DESCRIPTION OF DRAWINGS

The present invention is described through detailed illustration of embodiments referring to the attached drawings wherein:

FIG. 1 is a perspective view of a rim cover with a light-emitting apparatus of the present invention;

FIG. 2 is an exploded view of the light-emitting apparatus shown in FIG. 1;

FIG. 3 is a cross-sectional view of the light-emitting apparatus shown in FIG. 1; and

FIG. 4 is a planar view of the light-emitting apparatus shown in FIG. 1.

### DETAILED DESCRIPTION OF PREFERRED EMBODIMENTS

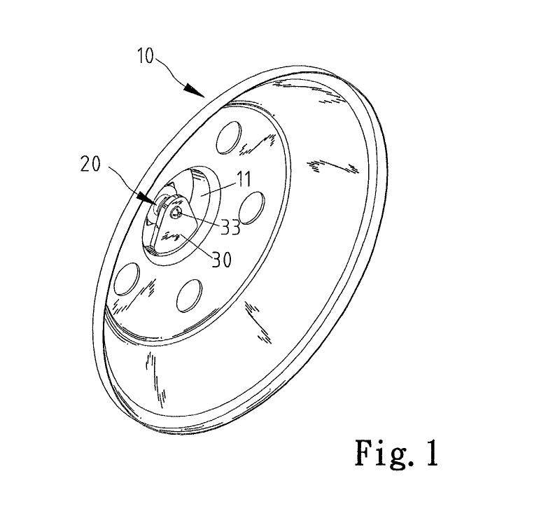

FIG. 1 shows a rim cover 10 on which a light-emitting apparatus according to the present invention is mounted. FIG. 1 shows one side of the rim cover 10 that will be concealed when the rim cover 10 is attached to a rim. The light-emitting apparatus is mounted on the rim cover 10 that is in turn attached to a rim so that the light-emitting apparatus is positioned in a space defined between the rim cover 10 and the rim.

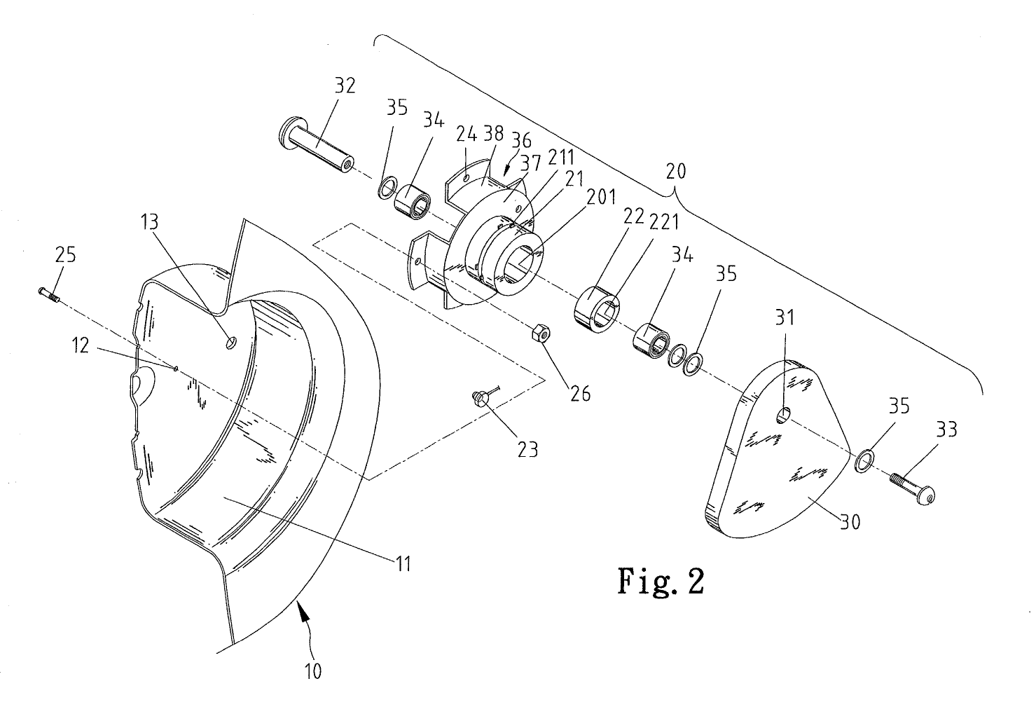

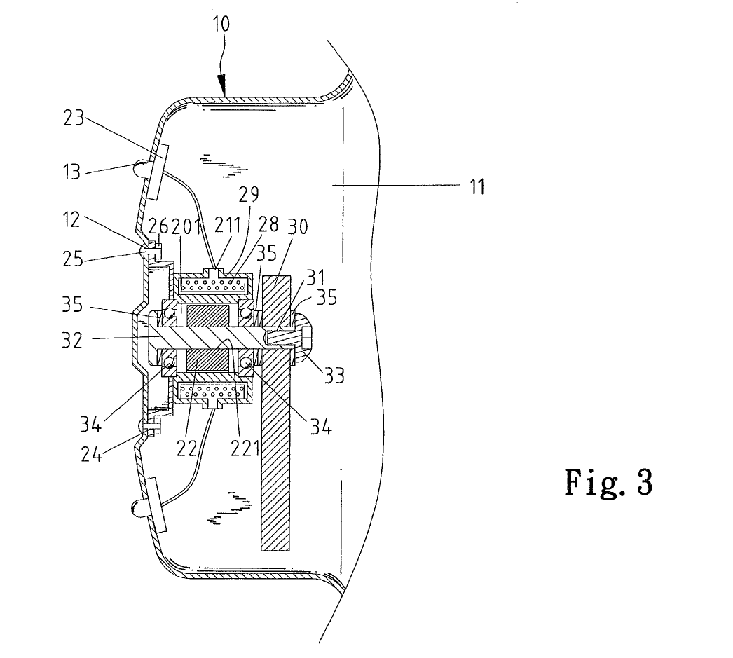

Referring to FIGS. 2 and 3, the rim cover 10 includes a central portion defining a space 11 for receiving elements of the light-emitting apparatus according to the present invention. The rim cover 10 includes a number of holes 12 and 13 defined through the central portion thereof.

The light-emitting apparatus includes a generator 20 and a light source. The generator 20 is attached to the rim cover 10 that the former can be rotated by means of the latter so as to generate electricity. The light source is connected with the generator 20 so that the former can be powered by means of the latter in order to emit light.

The generator 20 includes a mount 36. The mount 36 includes a disk 37 and a number of feet 38 extending from one side of the disk 37. The disk 37 defines a central hole. A hole 24 is defined through each of the feet 38. A bolt 25 can be inserted through each of the holes 12 and a corresponding one of the holes 24 for engagement with a nut 26, thus securing the mount 36 and therefore the generator 20 to the rim cover 10.

A coil device 21 is secured to an opposite side of the disk 37. As best seen in FIG. 3, the coil device 21 includes a coil 28 received in a casing 29. The casing 29 of the coil device 21 includes an internal cylindrical portion integrally connected with an external cylindrical portion by means of two annular portions. The coil 28 is mounted on the internal cylindrical portion of the casing 29 of the coil device 21. The external cylindrical portion of the casing 29 of the coil device 21 defines a number of holes 211. The internal cylindrical portion of the casing 29 of the coil device 21 defines a central hole 201.

A permanent magnet 22 is received in the central hole 201. As well know in the art, electricity can be produced in the coil 28 when the coil 28 is rotated with respect to the permanent magnet 22. The permanent magnet 22 defines a central hole 221.

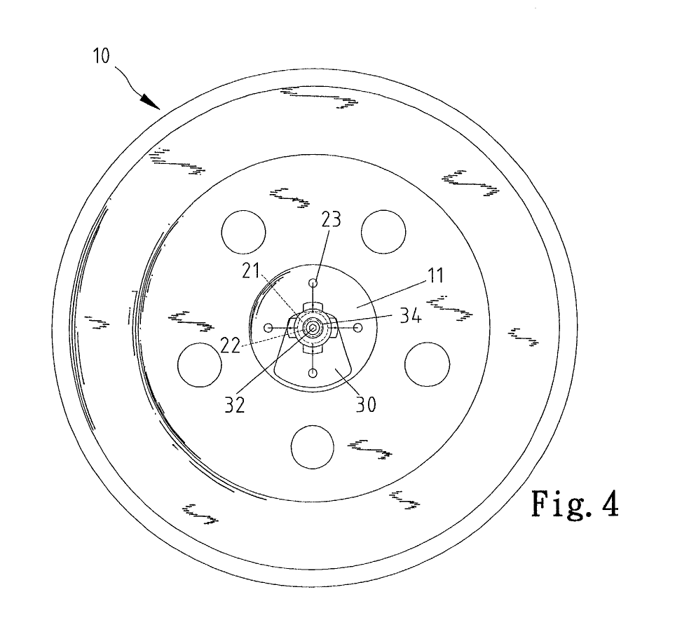

The permanent magnet 22 is securely mounted on a shaft 32. The shaft 32 is connected with the casing 29 of the coil device 21 through two bearings 34, thus allowing rotation of the coil device 21 with respect to the permanent magnet 22 for producing electricity in the coil 28. A weight 30 defining a hole 31 is secured to the shaft 32 so that the center of gravity of the weight 30 is positioned below the shaft 32 as most clearly shown in FIG. 4. Thus, when the coil device 21 is rotated, rotation of the shaft 32 is prevented.

Referring to FIG. 3, each of the bearings 34 includes an internal ring, an external ring, and a number of rollers positioned between the internal and external rings, thus allowing the internal ring to rotate with respect to the external ring. The shaft 32 includes a head formed at an end and a hole defined in an opposite end. A thread is formed on the wall of the hole defined in the shaft 32. The shaft 32 is inserted through a washer 35, one bearing 34, the permanent magnet 22, the other bearings 34, two more washers 35, the weight 30, and another washer 35. A thread of a bolt 33 is engaged with the thread formed on the wall of the hole defined in the shaft 32, thus firmly pressing the weight 30 against the internal ring of one of the bearings 34. The weight 30 is secured to the shaft 32 as the internal ring of each of the bearings 34 is secured to the shaft 32.

The light source includes a number of lights 23. Luminescent light source is preferred; however, other proper light sources can be used. Each of the lights 23 is connected with the coil 28 through a cable extending through a corresponding one of the holes 211 defined in the casing 29 of the coil device 21. Thus, the lights 23 can be powered to emit light by means of the coil 28. Each of the lights 23 is exposed to the external through a corresponding one of the holes 13, thus allowing light emitted from the lights 23 to be seen.

The light-emitting apparatus for a rim cover according to the present invention provides several advantageous features over the conventional light emitting apparatus mentioned in the Related Prior Art. Firstly, it is simple in structure. Secondly, the generator can generate electricity for the light source even the rim cover is rotated at a low speed. Thirdly, unintentional activating of the light source is prevented since no centrifugal switch is used. Fourthly, the elements are not vulnerable to mud and water. Fifthly, it is economic to use for not using a battery. Sixthly, all trouble related to replacement of a battery is eliminated. Seventhly, it is friendly to the environment to use for not using a battery.

A number of embodiments of the present invention have been described in detail for purposes of illustration. Those skilled in the art can derive a lot of variations from these embodiments after a study of this patent specification. Therefore, these embodiments shall by no means limit the scope of the present invention. The scope of the present invention can only be defined in the claims attached to and taken as a portion of this patent specification.

1. A light-emitting apparatus for a rim cover (10), the light-emitting apparatus comprising a light source (23) attached to the rim cover (10) and a generator (20) attached to the rim cover (10) for generation of electricity in order to power the light source (23) when the rim cover (10) is rotated.

2. The light-emitting apparatus according to claim 1 wherein the generator (20) includes a magnet (22) and a coil device (21) for rotation with respect to the magnet (22) when the rim cover (10) is rotated, thus generating electricity.

3. The light-emitting apparatus according to claim 2 wherein the coil device (21) includes a cylindrical configuration and the magnet (22) is co-axially received in the coil device (21).

4. The light-emitting apparatus according to claim 3 wherein the magnet (22) includes a cylindrical configuration, and the generator (20) includes a shaft (32) for carrying the magnet (22), two bearings (34) for bearing the shaft (32) in the coil device (31), thus allowing rotation of the coil device (31) with respect to the magnet (22).

5. The light-emitting apparatus according to claim 4 wherein the generator (20) includes a weight (30) attached to the shaft (32).

6. The light-emitting apparatus according to claim 5 wherein the generator (20) includes a mount (36) for mounting the coil device (21) on the rim cover (10).

7. The light-emitting apparatus according to claim 6 wherein the mount (36) includes a disk (37) and a number of feet (38) extending from one side of the disk (37) wherein the feet (38) are attached to the rim cover (10).

8. The light-emitting apparatus according to claim 7 wherein each of the feet (38) defines a hole (24) for receiving a bolt (25) for securing the mount (36) to the rim cover (10).

9. The light-emitting apparatus according to claim 5 wherein the coil device (21) is secured to an opposite side of the disk (37).

10. The light-emitting apparatus according to claim 9 wherein the coil device 21 includes a coil (28) and a casing (29) for receiving the coil (28).

11. The light-emitting apparatus according to claim 10 wherein the casing (29) includes an internal cylindrical portion integrally connected with an external cylindrical portion by means of two annular portions, and the coil (28) is mounted on the internal cylindrical portion of the casing (29).

12. The light-emitting apparatus according to claim 11 wherein the external cylindrical portion of the casing (29) defines at least one hole (211) for allowing a cable to extend from the coil (28) to the light source (23).
